(19) United States
(12) Patent Application Publication
(10) Pub. No.: US 2023/0062183 A1
(43) Pub. Date: Mar. 2, 2023

(54) THREE-DIMENSIONAL PRINTING

(71) Applicant: Hewlett-Packard Development Company, L.P., Spring, TX (US)

(72) Inventor: Krzysztof Nauka, Palo Alto, CA (US)

(73) Assignee: Hewlett-Packard Development Company, L.P., Spring, TX (US)

(21) Appl. No.: 17/798,321

(22) PCT Filed: Mar. 12, 2020
(86) PCT No.: PCT/US2020/022493

§ 371 Date: Aug. 9, 2022

(51) Int. Cl. B22F 10/28; B22F 12/33; B22F 12/43; B22F 12/47; B33Y 10/00; B33Y 30/00

(52) U.S. Cl. CPC B22F 10/28; B22F 12/33; B22F 12/43; B22F 12/47; B33Y 10/00; B33Y 30/00

(57) ABSTRACT

In one example, a three-dimensional (3D) printing method is disclosed. The 3D printing method may partition an entirety of a powder bed into a plurality of portions including a first portion and a second portion. The method may position an energy source over first portion of the powder bed, apply irradiation to the first portion until an irradiation dose is reached, and turn off irradiation to the first portion of the powder bed. The 3D printing method may rearrange the energy source and the powder bed to position the energy source over a second portion of the powder bed, apply irradiation to the second portion until the irradiation dose is reached, and turn off irradiation to the second portion of the powder bed.

### BACKGROUND

Three-dimensional (3D) printing can utilize additive layering to produce 3D objects from digital files or hard copy designs. The hard copy may be a two-dimensional representation of the design. In additive layering, successive layers of material are deposited on top of each other to form 3D objects. Some types of 3D printing may include powder beds containing powder material. The powder material may be repeatedly irradiated with an energetic beam to raise its temperature or to initiate desired chemical reactions for 3D printing. Examples of such processes include 3D printing of polymers using a broad array of high-power LEDs or lasers or metal printing using xenon flash lamps.

### BRIEF DESCRIPTION OF THE DRAWINGS

Examples of the disclosure will be rendered by reference to specific examples which are illustrated in the appended drawings. The drawings illustrate only particular examples of the disclosure and therefore are not to be considered to be limiting of its scope. The principles here are described and explained with additional specificity and detail through the use of the accompanying drawings.

FIG. 1 illustrates an example of a three-dimensional printing method according to the present disclosure.

FIG. 2 illustrates an example of a three-dimensional printing system for printing a three-dimensional object according to the present disclosure.

FIG. 3A illustrates an example of a three-dimensional printing system without suitable stitching along the boundary of the irradiated areas.

FIG. 3B illustrates another example of a three-dimensional printing system without suitable stitching along the boundary of the irradiated areas.

FIG. 4 is an example three-dimensional printing apparatus according to the present disclosure.

### DETAILED DESCRIPTION

As noted above, some types of 3D printing may involve repeated irradiation of powder beds. This irradiation increases the powder bed temperature or can trigger necessary chemical reactions that initiate the 3D object formation process. In some 3D printing systems, large powder beds that can deliver a higher throughput may be employed. Such large powder beds are also more efficient and have a lower cost per part. However, with large powder beds, a corresponding increase in the size of the irradiation source is not feasible due to economic and technological limitations of 3D printing. A smaller irradiation source for a large powder bed may not contemporaneously and uniformly irradiate the entirety of the powder bed. In other words, the powder bed may be too large for any meaningful and uniform irradiation of the powder bed at any one time.

Accordingly, examples of the present disclosure provide a three-dimensional (3D) printing method to facilitate the printing of three-dimensional objects. For some examples, although suitable for large powder beds, the 3D printing method may be applicable to any powder bed with an energy source that has an effective irradiation area that is smaller than the powder bed area. In one example of the present disclosure, the 3D printing method may partition an entirety of a powder bed into plural portions including a first and a second portion. The 3D printing method may position an energy source over a first portion of a powder bed, apply and then turn off irradiation when a suitable irradiation dose is reached. This step-like irradiation is continuously repeated for adjacent portions of the powder bed until the entirety of the powder bed is uniformly irradiated.

As such, in other examples, after the first portion of the powder bed is irradiated, the energy source and the powder bed are rearranged to position the energy source over a second portion of the powder bed. Irradiation may then be applied and turned off when the desired amount of irradiation dose is reached. In this manner, 3D printing systems with larger powder beds can be effectively utilized despite the economic and technological limitations thereof.

For some examples, a 3D printing system may include a movement mechanism to arrange the energy source and the powder bed to apply an amount of irradiation to successive portions of the powder bed until an entirety of the powder bed is irradiated.

For other examples, the movement mechanism of a 3D printing apparatus may arrange the energy source and the powder bed to apply continuous irradiation onto the powder bed. The energy source may start and stop the application of continuous irradiation outside of the powder bed to facilitate uniform irradiation.

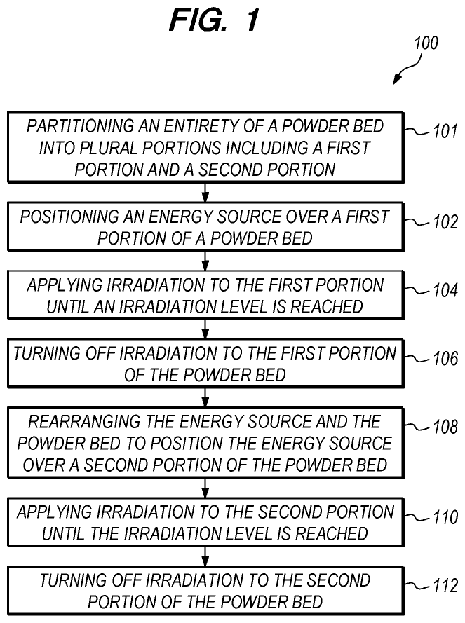

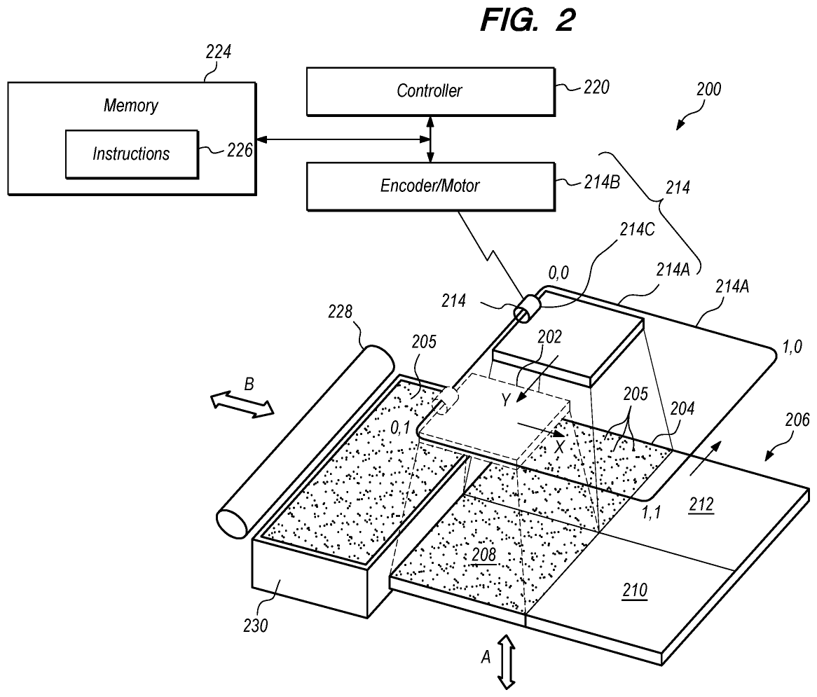

FIG. 1 illustrates an example of a three-dimensional (3D) printing method 100 for printing a three-dimensional object. The 3D objects may include various device types, components, parts, moldings, etc. In one example, this 3D printing method 100 may be implemented with a 3D printing system 200 (FIG. 2). 3D printing system 200 will now be described although some aspects have been omitted as to not unnecessarily obscure the present disclosure.

In FIG. 2, 3D printing system 200 may itself include an energy source 202 to sinter powder material 205 on a powder bed 206. Here, energy source 202 may be any irradiation source that can generate sufficient energy to sinter or melt powder bed material 205. In one example, energy source 202 may be a commercially available xenon lamp. In other examples, energy source 202 may be a pulsed gas discharge lamp. For some examples, energy source 202 may be a laser light source. For other examples, energy source 202 may be LEDs (light emitting diodes). In further examples, energy source 202 may be a vertical-cavity surface-emitting laser (VCSEL). In other examples, energy source 202 may output light at an intensity of between 10-25 kW/cm² or 3.6-90 MJ/cm².

Here, powder bed 206 may be a platform to receive powder material 205 from which the three-dimensional object is formed. For some examples, powder material 205 may be a polymer. For other examples, powder material 205 may be glass. In one example, powder material 205 may be a ceramic such as alumina and Al2O3. In other examples, powder material 205 may be hydroxyapatite. For some examples, powder material 205 may be a metal or metal alloy such as nickel, steel, aluminum, tungsten, titanium, copper, cobalt, etc.

Such powder material 205 may be received from a powder supply 230 which may be a container, a hopper or the like to store powder material 205 for building the 3D object. 3D printing system 100 may employ a spreader 228 to controllably feed powder material 205 from powder supply 230 onto powder bed 206. As shown, spreader 228 may traverse the direction B. Spreader 228 may spread powder material 205 into layers over powder bed 206. Powder material 205 may also be deposited over previously deposited layers. For some examples, spreader 228 may be a roller. Other types of material spreading devices may be utilized. As another example, spreader 228 may be a blade.

Powder bed 206 may be controllably moved in a vertical downward direction as shown by arrow A to increase the height of the work space as additional layers of powder material 205 gets deposited onto powder bed 206. A fusing agent may be applied to layers of powder material 205 in areas where powder material 205 is to be fused based on a digital file or hard copy two-dimensional representation of the 3D object design. The fusing agent can coat powder material 205 so that when exposed to irradiation, the fusing agent can absorb and convert the irradiation energy into thermal energy. The thermal energy then fuses the areas of powder material 205 to which the fusing agent has been applied. As each layer of powder material is deposited, this process is repeated layer-by-layer until the entirety of the 3D object is printed.

Referring to FIG. 2, in one example, a movement mechanism 214 (i.e., 214A-2140) may control the movement of energy source 202 relative to powder bed 206 to apply an amount of irradiation to successive portions 204, 208, 210, 212 of powder bed 206 until an entirety of powder bed 206 is irradiated. In one example, movement mechanism 214 includes a track/guide 214A disposed above powder bed 206 and extending around the periphery of powder bed 206. As can be seen, powder bed 206 and track/guide 214A are similarly dimensioned. A hollow cylindrical connector 214C and track/guide 214A are mated so that cylindrical connector 214 may glide on track/guide 214A.

It is to this cylindrical connector 214C that energy source 202 is attached. In this manner, energy source 202 can use track/guide 214A to reposition its location to successive portions 204, 208, 210, 212 of powder bed 206. Cylindrical connector 214C is also coupled to an encoder/motor 214B. In one example, encoder/motor 214B may be a linear actuator to move energy source 202 and to generate a feedback signal via position sensors to determine the position of energy source 202. Other examples of movement mechanism 214 may be utilized. For example, track/guide 214A may be a timing belt and/or pulley and gears coupled to encoder/motor 214B.

3D printing system 200 may also include a controller 220 and memory 224 having instructions 226. Controller 220 may control operations of 3D printing system 200. Controller 220 may be a semiconductor-based microprocessor, a central processing unit (CPU), an application specific integrated circuit (ASIC), a field-programmable gate array (FPGA), and/or other suitable hardware device.

Memory 224 may have stored thereon machine-readable instructions 226 which may also be computer readable instructions that controller 220 may execute. In one example, instructions 226 may be software instructions to execute 3D printing method 100 of FIG. 1. In another example, instructions 226 may include software instructions to control the delivery of energy by energy source 202 including the initiation and duration of irradiation. For some examples, instructions 226 may include software instructions to control movement mechanism 214. Although instructions 226 are discussed herein as a single set of instructions, it should be understood that the instructions 226 may include multiple sets of instructions without departing from a scope of 3D printing system 200.

Memory 224 may be an electronic, magnetic, optical, or other physical storage device that contains or stores executable instructions. The memory 224 may be, for example, Random Access memory (RAM), an Electrically Erasable Programmable Read-Only Memory (EEPROM), a storage device, an optical disc, and the like. The memory 224, which may also be referred to as a computer readable storage medium, may be a non-transitory machine-readable storage medium where the term “non-transitory” does not encompass transitory propagating signals.

In other examples, instead of the memory 224, 3D printing system 200 may include hardware logic blocks that may perform functions similar to the instructions 226. In yet other examples, 3D printing system 200 may include a combination of instructions and hardware logic blocks to implement or execute functions corresponding to the instructions 226. In any of these examples, the controller 220 may implement the hardware logic blocks and/or execute the instructions 226. Controller 220 may fetch, decode, and execute instructions 226 to control formation of sections of the 3D object in respective layers of powder material 205 to form the 3D object.

In operation, based on instructions 226, controller 220 may determine the areas on the surface of powder bed 206 that are to be fused together to form the 3D fabricated object. Controller 220 then causes spreader 228 to spread a layer of powder material 205 over powder bed 206. A fusing agent is applied to the areas of powder material 205 that are to be fused based on instructions 226. Controller 220 then causes energy source 202 to irradiate first portion 204. Controller 220 thereafter triggers encoder/motor 214B to move energy source 202 located at position 0,0 to successive portions of powder bed 206 until the entirety of powder bed 206 is irradiated. The process is then repeated until the 3D object is completely fabricated.

Referring now to FIG. 1, at block 101, 3D printing method 100 may include partitioning an entirety of powder bed 206 (FIG. 2) into plural portions including first portion 204, second portion 208, third portion 210 and fourth portion 212. By “partitioning,” it is meant that the entirety of powder bed 206 is subdivided into smaller areas or partitions. Each partition is sized to correspond to the effective irradiation area of energy source 202. Each partition may be associated with a corresponding position of energy source 202. That is, memory 224 may associate position 0,0 and first partition 204; position 0,1 and second partition 208; position 1,1 and third portion 210; and position 1,0 and fourth partition 212. In one example, the above-mentioned positions may be preprogrammed for execution by controller 220.

At block 102, 3D printing method 100 may include positioning energy source 202 (FIG. 2) over the first portion 204 of powder bed 206. In one example, this positioning is to dispose energy source 202 over powder bed 206 at startup. In other words, when the 3D printing system 200 (FIG. 2) is powered up, energy source 202 is at a home position 0,0 over first portion 204 and neither energy source 202 nor powder bed 206 need be moved.

At block 104, after energy source 202 is positioned over first portion 204, irradiation is applied to first portion 204 until an irradiation dose is reached. Successful 3D printing may entail raising the surface powder temperature. In some cases, a specific value of radiation intensity and irradiation time are needed to achieve a desired 3D printing effect. The irradiation intensity and irradiation time values are dependent on the effect desired, e.g., raising a local bed temperature to a desired level, melting powdered material, or initiating a chemical/physical process. For example, in the case of melting, a high irradiation intensity may be applied for a short duration. In other examples, a low irradiation intensity may be coupled with a long irradiation time.

For example, 3D printing of plastics may involve raising the powder material temperature to a specified temperature to melt and fuse the powder material into a solid. Insufficient irradiation may not melt and fuse plastic powder material. In one example, a user can set a not-to-exceed amount of irradiation that can be applied to powder material. In another example, the irradiation intensity may simply be based on the rating of the lighting source. For some examples, this process may be optimized by employing various combinations of irradiation intensity and irradiation time values. After parameters are optimized (desired printing result achieved), instructions for controller 220 may be developed based on the optimization process result.

In one example of the present disclosure, although suitable for large powder beds, 3D printing method 100 may be applicable to any powder bed with an energy source that has an effective irradiation area that is smaller than the powder bed area. Such a large powder-bed application is further discussed with reference to FIGS. 2A and 2B below.

At block 106, irradiation of the first portion 204 of powder bed 206 is turned off. Once the specific value of radiation intensity and irradiation time for first portion 204 is reached, irradiation is turned off. In some examples, irradiation may be accomplished by applying an irradiation pulse to first portion 204.

At block 108, after irradiation of first portion 204 is completed, energy source 202 and powder bed 206 are rearranged to position energy source 202 over a second portion 208 of the powder bed 206. In an example, rearrangement of energy source 202 and powder bed 208 is accomplished by retaining powder bed 206 in a stationary position and then moving energy source 202 over second portion 208. In this manner, the movement mechanism can be less complicated with overall reduced space requirements for the system since just the energy source (and not the powder bed) needs to be relocated.

For some examples, the rearrangement is by retaining energy source 202 in a stationary position and then moving powder bed 206 to position second portion 208 below energy source 202. Further yet, in other examples, rearrangement of energy source 202 and powder bed 206 can be accomplished by moving both energy source 202 and powder bed 206 to position second portion 208 of powder bed 206 below energy source 202. In this manner, rearrangement can be accomplished in a minimum amount of time.

At block 110, once rearrangement is completed, irradiation is applied to second portion 208 until the irradiation dose is reached. To ensure uniformity of irradiation, the same values of radiation intensity and irradiation time are applied to all portions of powder bed 206.

At block 112, irradiation to second portion 208 of powder bed 206 is turned off to complete irradiation of the second portion. This process is continuously repeated until irradiation of the entirety of powder bed 206 is effectuated.

Irradiation is uniformly delivered since 3D print quality may depend on uniformity of energy irradiation and the capability to deliver large energy doses within a limited duration. In some examples, a precise dose of radiation is applied, while in other examples, the energy dose may exceed a specified level.

Referring now to FIG. 2, an example 3D printing system 200 for printing a three-dimensional object is illustrated. As noted, 3D printing system 200 may include energy source 202 and powder bed 206.

Energy source 202 may be any source that can irradiate powder material 205 in powder bed 206 which is itself positioned below energy source 202. In one example, energy source 202 can be employed for irradiation of relatively larger powder beds. As used herein, a large powder bed may have an energy source with an effective irradiation area that is smaller than the area of the powder bed. In this example, powder bed 206 is a large powder bed because energy source 202 has an irradiation area AB (FIG. 2) smaller than the area CD of powder bed 206. Note that this irradiation area AB is based on that area of powder bed 206 that can be contemporaneously irradiated. Note also that irradiated area AB and first portion 204 may be one and the same.

As shown in FIG. 2, 3D printing system 200 may further comprise a movement mechanism 214. Movement mechanism 214 is to arrange energy source 202 and powder bed 206 to apply an amount of irradiation to successive portions 204, 208, 210, 212 of powder bed 206 until an entirety of powder bed 206 is irradiated. By successive portions, it is meant that irradiation is applied to each portion of powder bed 206 one at a time or in a step-like manner. For example, irradiation may be applied to second portion 208, and then, irradiation is complete and ceases. Irradiation is then applied to third portion 210. After irradiation to third portion 210 is completed, irradiation of fourth portion 212 is then effectuated.

Thus, movement mechanism 214 is to position energy source 202 over first portion 204 of powder bed 206 and then to apply an irradiation pulse to this first portion of the powder bed. Movement mechanism 214 may also rearrange energy source 202 and powder bed 206 to position energy source 202 over second portion 208 of powder bed 206; and then apply this same amount of irradiation pulse to second portion 208 of powder bed 206.

In this example, irradiation begins with first portion 204 and proceeds in a counter clockwise direction. Specifically, irradiation may begin at home position 0,0 and proceed in a step-like manner in the Y direction/dimension through positions 0,1 and 1,1 and ending at position 1,0 to irradiate fourth portion 212. However, in another example, irradiation may be in a clockwise manner. Specifically, irradiation may begin at home position 0,0 and proceed in the X direction/dimension through positions 1,0 and 1,1 and ending at position 0,1 to irradiate second portion 208. In a further example, irradiation may be random and may irradiate non-contiguous portions until the entirety of powder bed 206 is irradiated.

Note that in FIG. 2, a number of the portions of powder bed 206 are adjacent to each other. This placement facilitates step-like irradiation from one portion to a neighboring adjacent portion of powder bed 206. For example, first portion 204 is adjacent to second portion 208 which is adjacent to third portion 210 which is, in turn, adjacent to fourth portion 212 so that step-like irradiation can proceed from first portion 204 through fourth portion 212.

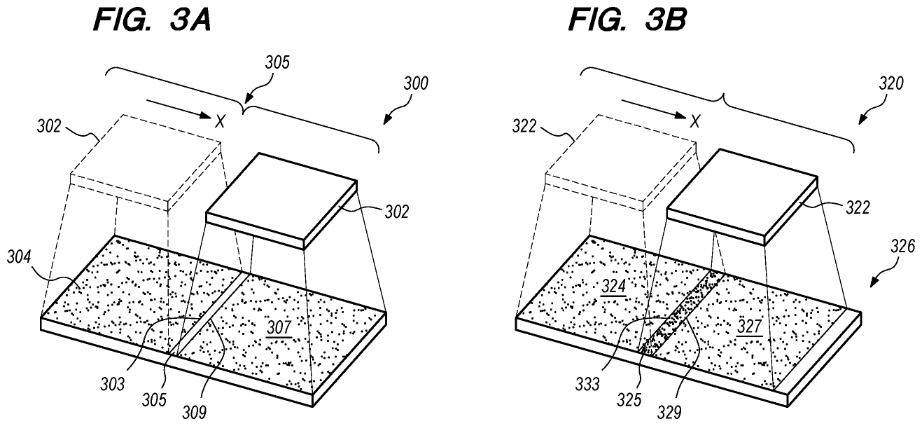

Furthermore, all of the adjacent portions of powder bed 206 are meant to be properly stitched in some examples. By stitching, it is meant that the boundaries of adjacent irradiated portions are specified to avoid excessive or insufficient irradiation at the boundaries as shown in FIGS. 3A and 3B. Stitching may also refer to the choice of irradiated energy distribution and movement of energy source 202 to provide the same irradiation conditions over the entire powder bed 206. Stitching may be accomplished by defining parameters such that controller 220 can place energy source 202 at successive locations that meet the specified parameters. An allowable overlap range may be defined such that placement of energy source 202 is within the overlap range. As another example, adjacent irradiated areas may not overlap and the gap between such adjacent areas is within a predefined limit such as 1 um.

FIG. 3A illustrates an example 3D printing system 300 without suitable stitching at the boundary between adjacent irradiated portions. In FIG. 3A, 3D printing system 300 includes an energy source 302 and a powder bed 306. As shown, using step-like irradiation in direction X, a first portion 304 is irradiated followed by a second portion 307 of powder bed 306.

A boundary 303 demarcates the end of irradiated portion 304. An adjacent boundary 309 demarcates the beginning of irradiation of portion 307. However, because boundary 303 is before boundary 309 and both boundaries do not coincide, a gap 305 that receives insufficient or little or no irradiation is formed between the boundaries. As such, 3D printing system 300 is capable of printing three-dimensional objects provided the specification calls for no printing within gap 305.

FIG. 3B illustrates an example 3D printing system 320 without suitable stitching at the boundary between adjacent irradiated portions. In FIG. 3B, 3D printing system 320 includes an energy source 322 and a powder bed 326. As shown, using step-like irradiation in direction X, a first portion 324 is irradiated followed by a second portion 327 of powder bed 326. A boundary 333 demarcates the end of irradiated portion 324. Another boundary 329 demarcates the beginning of irradiated portion 327.

Here, because boundary 333 and boundary 329 are not co-incidental, and boundary 333 extends into portion 327 while boundary 329 extends into portion 324, an overlap area 325 that receives excessive irradiation is formed. As such, 3D printing system 320 may print three-dimensional objects provided the specification specifies that objects within overlap area 325 can receive a higher irradiation dose.

In some examples, a specific irradiation dose may be specified, and exceeding this limit does not deleteriously impact print quality. An example may be application of xenon flash heating after printing each layer in the 3D metal binder process. In this case, xenon flash is used to raise metal powder's temperature to evaporate the binder solvent (e.g., around 200° C.). Raising the temperature higher (within acceptable limits) or repeating flash heating (which may occur when flash heated areas partially overlap, FIG. 3B) will not affect quality of the printed component. Thus, stitching misalignment shown in FIG. 3A may not be acceptable while misalignment shown in FIG. 3B is allowable.

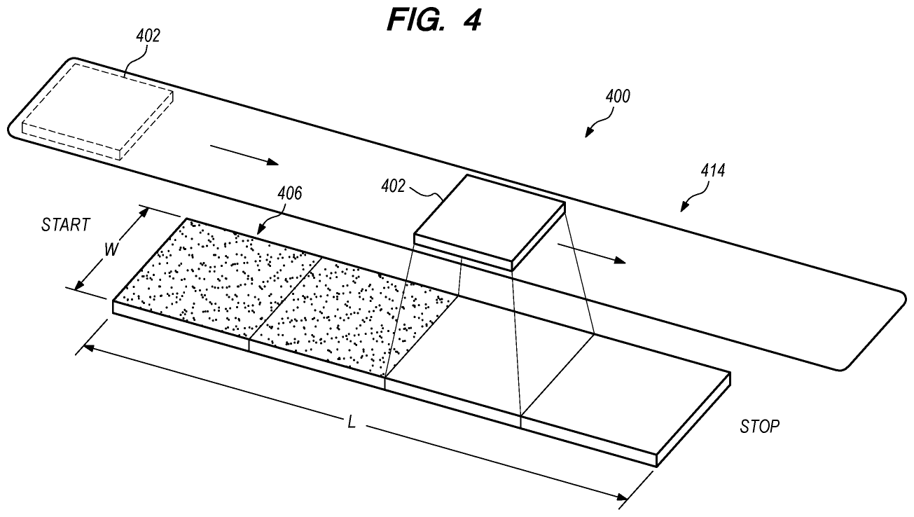

FIG. 4 is an example 3D printing apparatus 400 for printing a three-dimensional object according to the present disclosure. In FIG. 4, 3D printing apparatus 400 may include a powder bed 406 and an energy source 402 to irradiate powder bed 406.

3D printing apparatus 400 may further comprise a movement mechanism 414 to arrange energy source 402 and powder bed 406 to apply continuous irradiation onto powder bed 406. Energy source 402 is to start and stop the application of continuous irradiation outside of powder bed 406. In FIG. 4, the start location outside the powder bed 406 for applying continuous irradiation is shown as START while the ending location is shown as STOP. Energy source 402 is turned on at location START, and a continuous sweep of energy source 402 over the entirety of powder bed 406 is applied until the entirety of powder bed 406 is irradiated, after which at the STOP location, energy source 402 is turned off.

If the sweep starts and ends within powder bed 406, the first and last irradiated portions may need to be exposed to irradiation for a longer or shorter time than the portions in between to achieve the same degree of irradiation and to provide uniform 3D conditions on powder bed 406. For some examples of the present disclosure, energy of the energy source (e.g., 402) may be modified by changing either a movement speed of energy source 402 or an intensity of energy source 402 or both. Here, note that powder bed 406 is elongated. By elongated, it is meant that the width W is shorter than the length L. Note also that this width W may be equal to the width of the irradiated area and energy source 402 to facilitate a single sweep from one end of powder bed 406 to another.

While the above is a complete description of specific examples of the disclosure, additional examples are also possible. Thus, the above description should not be taken as limiting the scope of the disclosure, which is defined by the appended claims along with their full scope of equivalents.

I claim:

1. A three-dimensional printing method comprising:
partitioning an entirety of a powder bed into a plurality of portions including a first portion and a second portion;
positioning an energy source over the first portion of the powder bed;
applying irradiation to the first portion until an irradiation dose is reached;
turning off irradiation to the first portion of the powder bed;
rearranging the energy source and the powder bed to position the energy source over a second portion of the powder bed;
applying irradiation to the second portion until the irradiation dose is reached; and
turning off irradiation to the second portion of the powder bed.

2. The method of claim 1 wherein rearranging the energy source and the powder bed is by
retaining the powder bed in a stationary position; and
moving the energy source over the second portion of the powder bed.

3. The method of claim 1 wherein rearranging the energy source and the powder bed is by
retaining the energy source in a stationary position; and
moving the powder bed to position the second portion of the powder bed below the energy source.

4. The method of claim 1 wherein rearranging the energy source and the powder bed is by
moving the energy source; and
moving the powder bed to position the second portion of the powder bed below the energy source.

5. The method of claim 1 wherein the first portion of the powder bed and the second portion of the powder bed are adjacent.

6. The method of claim 5 further comprising a gap between the first portion and the second portion of the powder bed.

7. The method of claim 5 wherein the first portion and the second portion partially overlap to form an overlap area.

8. A three-dimensional printing system comprising:
a powder bed to receive powder material;
an energy source with an irradiation area smaller than an area of the powder bed; and
a movement mechanism to arrange the energy source and the powder bed to apply an amount of irradiation to successive portions of the powder bed until an entirety of the powder bed is irradiated.

9. The system of claim 8 wherein
the movement mechanism is position to the energy source over a first portion of the powder bed; and
applying an irradiation pulse to the first portion of the powder bed.

10. The system of claim 9 wherein the movement mechanism is to rearrange the energy source and the powder bed to position the energy source over a second portion of the powder bed; and
applying an irradiation pulse to the second portion of the powder bed.

11. The system of claim 10 wherein the first portion of the powder bed and the second portion of the powder bed are adjacent.

12. The system of claim 11 wherein the first portion and the second portion can form either an overlap area or a gap

13. An apparatus for three-dimensional printing, the apparatus comprising:
a powder bed;
an energy source to irradiate the powder bed; and
a movement mechanism to arrange the energy source and the powder bed to apply continuous irradiation onto the powder bed, wherein the energy source is to start and stop applying the continuous irradiation outside of the powder bed.

14. The apparatus of claim 13 wherein energy of the energy source is modified by changing a movement speed or an intensity of the energy source.

15. The apparatus of claim 13 wherein the powder bed is elongated.
